(19) United States
(12) Patent Application Publication
(10) Pub. No.: US 2013/0235740 A1
(43) Pub. Date: Sep. 12, 2013

(54) METHOD AND MOBILE TERMINAL FOR MANAGING CIRCUIT SWITCHED FALLBACK PROCEDURE AND NETWORK REGISTRATION

(71) Applicant: PANTECH CO., LTD., Seoul (KR)

(72) Inventors: Myong Ju KIM, Seoul (KR); Ha Na LEE, Seoul (KR)

(73) Assignee: PANTECH CO., LTD., Seoul (KR)

(21) Appl. No.: 13/685,106

(22) Filed: Nov. 26, 2012

(30) Foreign Application Priority Data
Mar. 7, 2012 (KR) 10-2012-0023355

(51) Int. Cl. H04W 24/04

(52) U.S. Cl. CPC H04W 24/04
USPC 370/252; 370/328

(57) ABSTRACT

A method that uses a processor to manage a circuit switched fall back (CSFB) procedure includes connecting to a circuit switched network for the CSFB procedure, processing, using the processor, a voice call using the circuit switched network, and determining whether to register to a packet switched network according to a connection possibility of the packet switched network. A mobile terminal includes a first mobile communication modem to connect to a packet switched network, a second mobile communication modem to switch from the packet switched network to a circuit switched network, and a controller to determine whether to re-register to the packet switched network according to a connection possibility of the packet switched network.

### CROSS-REFERENCE TO RELATED APPLICATION

This application claims priority from and the benefit under 35 U.S.C. §119(a) of a Korean Patent Application No. 10-2012-0023355, filed on Mar. 7, 2012, which is incorporated herein by reference for all purposes.

### BACKGROUND

1. Field

The present disclosure relates to a method and mobile terminal for managing a circuit switched fallback procedure and a network registration, and more particularly to, a method for controlling a mobile communication terminal to improve receiving/sending voice call by reducing missing of a voice call and a registration delay or failure to a packet switching network when switching from a circuit switching network to the packet switching network after a circuit switched fall back, and a mobile communication terminal using the same.

2. Discussion of the Background

Long Term Evolution (LTE) refers to a next-generation communication technology evolved from 3rd-generation (3G) mobile communication technology, such as Wideband Code Division Multiple Access (WCDMA), Time Division Synchronous CDMA (TD-SCDMA), and CDMA2000. LTE is also called 3.9th-generation (3.9G) mobile communication since it is regarded as an intermediate standard between the 3rd-generation (3G) mobile communication technology represented by Wideband Code Division Multiple Access (WCDMA) and Code Division Multiple Access 2000 (CDMA2000) and 4th-generation (4G) mobile communication technology, and is one of leading candidates for the 4th-generation mobile communication technology in addition to WiBro evolution. Mobile communication methods prior to a new communication method, such as LTE and WiMAX, are sometimes collectively expressed as legacy mobile communication methods.

LTE is configured to support a voice call based on IP Multimedia Subsystem (IMS), but most service providers have not adopted IMS, and small number of service providers have an interest to adopt IMS. Accordingly, in the LTE standard supporting only the packet switching network (hereinafter, a PS network), the circuit switched fall back (hereinafter, CSFB) service is proposed to support the voice call.

In the CSFB service, if a voice call or phone call is received while a mobile communication terminal supporting LTE is in connection with an LTE network, the LTE connection is disconnected and fall-back is made to a circuit switching network (hereinafter, referred to as a CS network) of 3G WCDMA or 2G GSM to provide a voice call service.

Further, if the mobile communication terminal supporting LTE is in connection with a PS network (e.g., LTE), the mobile communication terminal is shifted to the CS network to make a voice call according to the CSFB process. After the termination of the voice call, the mobile communication terminal shifts from the CS network to the PS network and is registered to the PS network.

However, while the mobile communication terminal attempts to make a reconnection with the PS network, an electric field or wireless communication environment of the PS network may be bad. Thus, the registration to the PS network may be frequently delayed or unsuccessful. Since the mobile communication terminal attempts a connection to the PS network in a state where the connection to the CS network is released after terminating a voice call, the terminal is in a disconnected state from both the CS network and the PS network, and thus the mobile communication terminal cannot send or receive a call. If the registration attempt to the PS network is delayed or unsuccessful, there is a higher possibility for the mobile communication terminal to miss a voice call from another mobile communication terminal during the time period.

Generally, the CS network has a call sending/receiving success rate of about 99% or above, and the PS network has a call sending/receiving success rate of just about 90% to about 5%. This phenomenon frequently occurs in the downtown area or when the mobile communication terminal is moving.

Therefore, there is a demand for a technique capable of reducing the registration to the PS network from being delayed or failing, and ensuring a terminal to stably send or receive a call without missing a mobile terminating voice call, when the terminal shifts from the CS network to the PS network after CSFB.

### SUMMARY

Exemplary embodiments of the present invention provide a method and mobile terminal for managing a circuit switched fallback procedure and a network registration.

According to the exemplary embodiments of the present invention, the possibility of switching to the PS network is determined based on information about the PS network, which is previously collected and stored, and the switching to the PS network is attempted based on the determination result. Therefore, the continual connection of the mobile communication terminal to a communication network is ensured, and a communication-unavailable state may be avoided. In addition, the registration delay or failure to the PS network may be adaptively managed after CSFB.

Additional features of the invention will be set forth in the description which follows, and in part will be apparent from the description, or may be learned by practice of the invention.

Exemplary embodiments of the present invention provide a method that uses a processor to manage a circuit switched fall back (CSFB) procedure including connecting to a circuit switched network for the CSFB procedure, processing, using the processor, a voice call using the circuit switched network, and determining whether to register to a packet switched network according to a connection possibility of the packet switched network.

Exemplary embodiments of the present invention provide a mobile terminal including a first mobile communication modem to connect to a packet switched network, a second mobile communication modem to switch from the packet switched network to a circuit switched network, and a controller to determine whether to re-register to the packet switched network according to a connection possibility of the packet switched network.

Exemplary embodiments of the present invention provide a method that uses a processor to manage a circuit switched fall back (CSFB) procedure including connecting to a circuit switched network for the CSFB procedure, processing, using the processor, a voice call using the circuit switched network, and determining whether to register to a packet switched network if a guard time expires.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a mobile communication terminal according to an exemplary embodiment of the present invention.

FIG. 2 is a flowchart illustrating a method for controlling a mobile communication terminal in a CSFB procedure for sending a voice call according to an exemplary embodiment of the present invention.

FIG. 3 is a flowchart illustrating a method for controlling a mobile communication terminal in a CSFB procedure for receiving a voice call according to an exemplary embodiment of the present invention.

FIG. 4 is a flowchart illustrating a method for measuring and storing PS network information according to an exemplary embodiment of the present invention.

FIG. 5 shows a table including radio resource measurement data for a PS network according to an exemplary embodiment of the present invention.

FIG. 6 shows a table including radio resource measurement data for a PS network measured by an inter-RAT measurement according to an exemplary embodiment of the present invention.

FIG. 7 is a flowchart illustrating a method for managing a registration to a PS network after terminating a CSFB procedure according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

Hereinafter, a method for controlling a mobile communication terminal for an improved voice call receiving performance and a mobile communication terminal using the same will be described in detail with reference to the drawings.

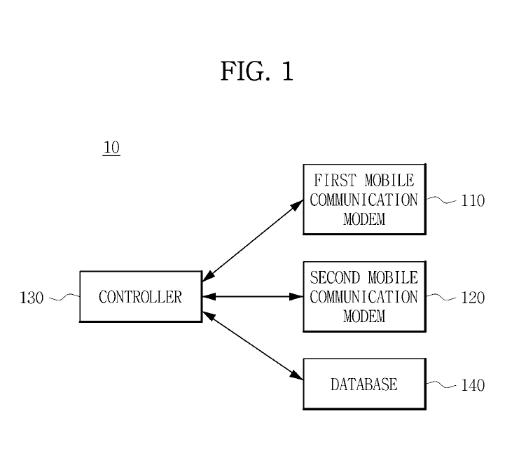

FIG. 1 is a block diagram showing a mobile communication terminal according to an exemplary embodiment of the present invention. Although some components of a mobile communication terminal 10 are not illustrated in FIG. 1, the configuration of the mobile communication terminal 10 may include one or more processors, memories, antennas, display panels (e.g., touch screen display), input/output interfaces, and the like to support dual mode connections to a packet switched (PS) network and a circuit switched (CS) network.

Referring to FIG. 1, a mobile communication terminal 10 includes a first mobile communication modem 110 for performing a data communication through a packet switching network (a PS network), a second mobile communication modem 120 for performing a voice communication through a circuit switching network (a CS network), and a controller 130 for controlling the first and second mobile communication modems 110 and 120 and communication operations. Further, the mobile communication terminal 10 may include a separate database 140 for storing data relating to the communication operations. The first and second mobile communication modems 110 and 120 are illustrated separately for description purposes only; however, aspects need not be limited thereto such that the first and second mobile communication modems 110 and 120 may be integrated.

The mobile communication terminal 10 may perform a data communication through the first mobile communication modem 110. While connecting to a PS network and staying in an idle state, a voice call may be received or may be requested by the mobile communication terminal 10 and the mobile communication terminal 10 may connect through the second mobile communication modem 120 to the CS network and perform a voice communication. Various data for such network-shifting communication may be stored in the database 140, and such communication operations may be controlled by the controller 130. However, since the first mobile communication modem 110, the second mobile communication modem 120, the controller 130, and the database 140 are included in the mobile communication terminal 10, the operations of each component may be described as operations of the mobile communication terminal 10.

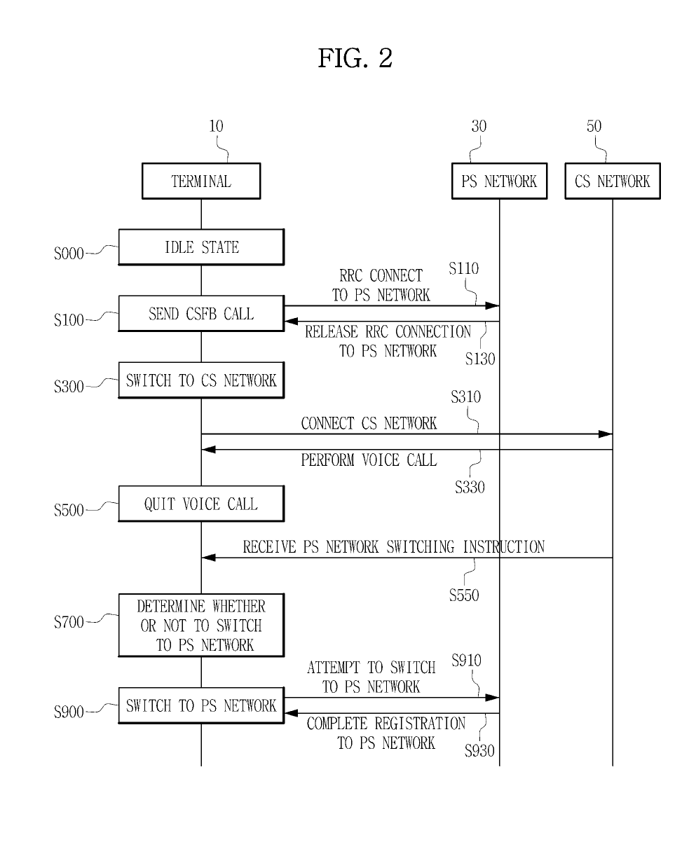

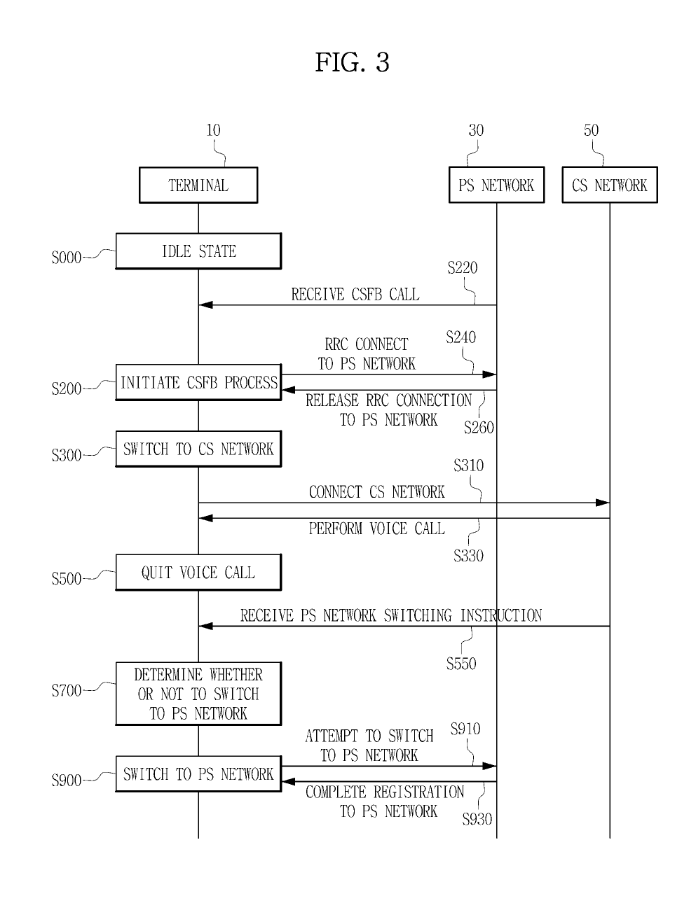

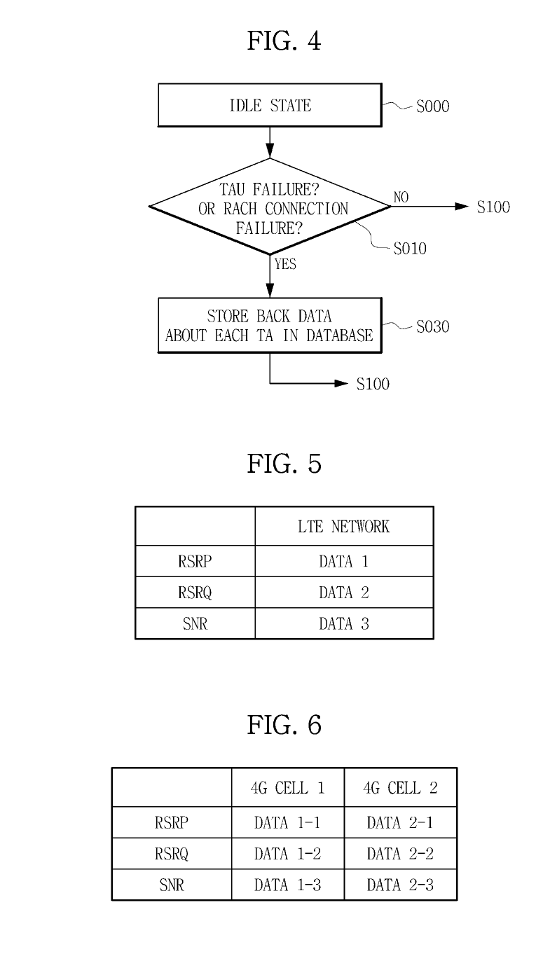

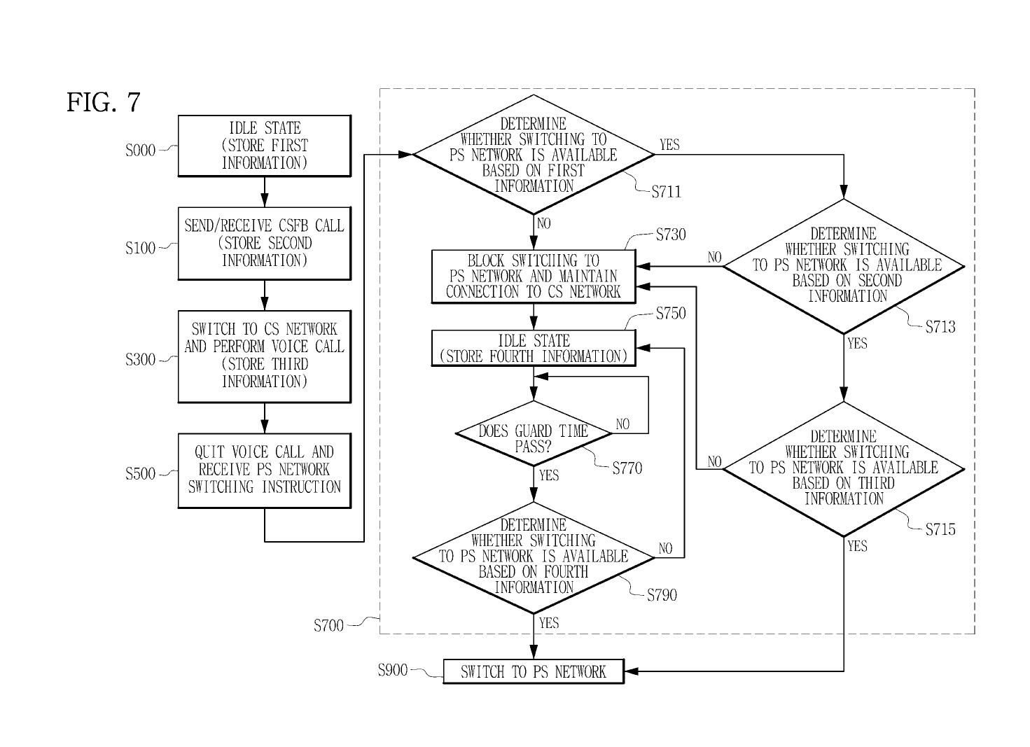

FIG. 2 is a flowchart illustrating a method for controlling a mobile communication terminal in a CSFB procedure for sending a voice call according to an exemplary embodiment of the present invention, and FIG. 3 is a flowchart illustrating a method for controlling a mobile communication terminal in a CSFB procedure for receiving a voice call according to an exemplary embodiment of the present invention. Referring to FIG. 2 and FIG. 3, a method for switching from a CS network to a PS network after circuit switched fall back (CSFB) will be described. FIG. 2, FIG. 3, FIG. 4, and FIG. 7 will be described as if performed by the mobile communication terminal 10 shown in FIG. 1, but is not limited as such.

The mobile communication terminal 10 connecting to the PS network 30 is in an idle state in operation S000.

The PS network 30 splits data into blocks, which are also called packets, and adds receiver address information or the like to a header of each packet and sends the packet. In the PS network 30, the data is transmitted to a receiver according to the information added to the header of each packet. A private network may be used for a point-to-point communication between two users without a call switching, and allows a rapid transport of 64 kbps to 1,920 kbps.

The PS network 30 may include Long Term Evolution (LTE), Wireless Broadband Internet (WirBro), Worldwide Interoperability for Microwave Access (WiMAX)-Advanced (IEEE 802.16m), LTE-Advanced, WiBro Evolution, or the like.

The mobile communication terminal 10 may include various types of mobile communication terminals supporting a voice call and data communication, such as smart phones, personal digital assistant (PDA), and tablet computers. The mobile communication terminal 10 may use the PS network 30 when performing a data communication with other mobile communication terminals, and may use the CS network 50 when making a voice call.

If a connection between two points is requested, in the CS network 50, an exchanger continuously connects the requested line for a communication until the communication ends. The CS network 50 may include various types of 3-generation (3G) mobile communication networks such as Wideband Code Division Multiple Access (WCDMA) and Code Division Multiple Access (CDMA) 2000. Further, the CS network 50 may include other circuit switched networks of the 3rd-generation networks or 2nd-generation networks (e.g. GSM network).

In operation S000, the mobile communication terminal 10 is in an idle state in connection with the PS network 30 without performing a communication. If the mobile communication terminal 10 is in an active state and performing a data communication, the location of the mobile communication terminal 10 is updated in the PS network 30 based on the unit of a cell. However, if the mobile communication terminal 10 is in an idle state without performing a data communication, the location of the mobile communication terminal 10 is updated in the PS network 30 based on the unit of tracking area (TA). In the PS network 30, several neighboring eNBs (base stations) are grouped and defined as a single TA. If the mobile communication terminal 10 is in an idle state and data traffic toward the mobile communication terminal 10 is generated, the TA wakes up the mobile communication terminal 10 to receive the data, and this wake up operation becomes a unit of paging.

In the PS network 30, the latest location information of the mobile communication terminal 10 is obtained in order to support the communication of the mobile communication terminal 10. If the mobile communication terminal 10 falls into an idle state, tracking area update (hereinafter, referred to as TAU) may be performed. The mobile communication terminal 10 may transmit a TAU message requesting TAU to the PS network 30 whenever TA is changed, in order to perform the TAU. The mobile communication terminal 10 transmits the TAU message through a random access channel (hereinafter, referred to as RACH), which is an uplink dedicated channel, to the PS network 30.

However, a problem may occur while the mobile communication terminal 10 is transmitting the TAU message through the RACH to the PS network 30. For example, when a terminal transmits a TAU message through the RACH to the LTE network, the TAU may fail or the connection to the RACH may fail.

If the TAU fails or the connection to the RACH fails, back data (first information) about each TA of the PS network 30 may be collected and used as a criterion for determining the possibility of switching to the PS network after the CSFB (“connection possibility of the PS network after CSFB”). A database 140 (see FIG. 1) about each TA may be built with the back data. The back data may be used to determine a registration procedure to the PS network after terminating a voice call in the CSFB procedure.

FIG. 4 is a flowchart illustrating a method for measuring and storing PS network information according to an exemplary embodiment of the present invention. Operations S000, S010, and S030 illustrated in FIG. 4 may be performed during the operations S000 illustrated in FIG. 2, FIG. 3, or FIG. 7. Referring to FIG. 4, while the mobile communication terminal 10 is in an idle state in operation S000, the mobile communication terminal 10 may attempt TAU and RACH connection. In operation S010, it may be determined whether the TAU attempt or the RACH connection attempt is failed. If the mobile communication terminal 10 fails in the TAU or fails in the connection to the RACH as determined in operation S010, the back data about each TA may be stored in the database 140 in operation S030. The back data indicates a connection failure rate in TAU or in RACH connection, and the like.

The back data stored in the database 140 may include at least one of a TAU failure frequency and a RACH connection failure frequency, and the database 140 may further store the information of the PS network 30 with which the mobile communication terminal fails in TAU or in RACH connection along with the back data indicating a connection failure rate. The information of the PS network 30 stored in the database 140 may include a cell ID, a tracking area code (TAC), and a RACH ID associated with the PS network 30.

In order to enhance successful switching from the CS network 50 to the PS network 30 after the CSFB and to evaluate the success possibility of the switching, the back data (first information) of the PS network 30 collected in an idle state of the mobile communication terminal 10 in operation S000 may be used as a criterion for determining the possibility of switching to the PS network. Based on the determination associated with the back data, the failure of the switching to the PS network 30 may be prevented or reduced by attempting the switching to the PS network 30 if the back data of the PS network 30 is good. For example, the mobile communication terminal may determine the back data of the PS network is good if the TAU failure frequency and/or the RACH connection failure frequency is less than or equal to a threshold failure rate.

If a CSFB voice call is received by the mobile communication terminal 10 in an idle state or the mobile communication terminal 10 requests a CSFB voice call to another terminal, the connection to the PS network 30 may be released in operations S100 of FIG. 2 or FIG. 7, or in operation S200 of FIG. 3.

Referring back to FIG. 2, the mobile communication terminal 10 sends a voice call (a CSFB call), e.g., a user inputs a dial or operates a send key to send a voice call in operation S100. If the user of the mobile communication terminal 10 attempts a CSFB voice call in operation S 100, the mobile communication terminal 10 has a Radio Resource Control (RRC) connection with the PS network 30 in operation S110, and releases the RRC connection with the PS network 30 in operation S130.

Referring back to FIG. 3, if the mobile communication terminal 10 receive a voice call (a CSFB call), the mobile communication terminal 10 receives a paging signal for the voice call from the PS network 30 in operation S220. Next, the mobile communication terminal 10 having a RRC connection with the PS network 30, in operation S240, releases the RRC connection with the PS network 30 in operation S260. Subsequent CSFB operations S300, S310, S330, S500, S550, S700, S900, S910, and S930 illustrated in FIG. 3 correspond to those operations illustrated in FIG. 2.

Referring to FIG. 2 and FIG. 3, the mobile communication terminal 10 may switch to CS network 50 in operation S300. The mobile communication terminal 10 may connect to the CS network 50 and transmit a response signal in operation S310, and the mobile communication terminal 10 may perform a voice communication via the CS network 50 in operation S330. After terminating the voice communication in operation S500, the mobile communication terminal 10 may receive an instruction to switch to the PS network 30 in operation S550. In order to reduce the re-registration failure to the PS network 30, the mobile communication terminal 10 may determine whether to switch back to the PS network 30 based on accumulated data including the back data collected in idle state in operation S700. If the mobile communication terminal 10 determines to switch back to the PS network 30 in operation S700, the mobile communication terminal 10 may attempt to switch to the PS network 30 in operation S910. If the switching attempt is successful, registration to the PS network 30 is completed in operation S930. If the mobile communication terminal 10 determines not to switch back to the PS network 30 in operation S700, the mobile communication terminal 10 may evaluate communication environment of the PS network 30 and may set a timer to delay the switching back to the PS network 30.

In operations S100 of FIG. 2 or FIG. 7, or in operation S200 of FIG. 3, the mobile communication terminal 10 may collect and store wireless environment data (second information) about the PS network 30 to which the mobile communication terminal 10 connects.

FIG. 5 shows a table including radio resource measurement data for a PS network according to an exemplary embodiment of the present invention. Referring to FIG. 5, the mobile communication terminal 10 may build a data table in the database 140 with the wireless environment data of the PS network 30. The wireless environment data of the PS network 30 is used as a criterion for determining the possibility of switching to the PS network after CSFB.

The wireless environment data of the PS network 30 may be collected through a network access at a point of starting sending or receiving a voice call request, or before or after starting sending/receiving the voice call request. The collected wireless environment data of the PS network 30 may include at least one of a reference signal received power (RSRP), a reference signal received quality (RSRQ), and a signal-to-noise ratio (SNR). RSRP represents an intensity of a signal obtained from the PS network 30, RSRQ represents a quality of the obtained signal intensity, and SNR represents a signal-to-noise ratio (in the unit of dB).

If the mobile communication terminal 10 starts sending or receiving a CSFB call, the wireless environment data (second information) of the PS network 30 may be collected and used as a criterion for determining the possibility of switching to the PS network after CSFB.

Referring back to FIG. 2 and FIG. 3, after sending or receiving a CSFB call and the connection to the PS network 30 being released, the mobile communication terminal 10 may switch to the CS network 50 and perform a voice call in operation S300. The mobile communication terminal 10 may connect to the CS network 50 in operation S310, and perform a voice call in operation S330.

Since the mobile communication terminal 10 performs a communication by using the PS network 30 and then switches to the CS network 50 when sending or receiving a CSFB voice call, the switching process is expressed as a fall back from a higher-level network to a lower-level network, e.g., from 4G to 3G. This method is called circuit switched fall back (CSFB), since a circuit switched network of the lower-level network is used for the voice communication.

In operation S300, wireless environment data (third information) about each cell of a PS network 30 neighboring to the CS network 50 to which the mobile communication terminal 10 has been connected is collected and stored while a voice call is performed.

FIG. 6 shows a table including radio resource measurement data for a PS network measured by an inter-RAT measurement according to an exemplary embodiment of the present invention. Referring to FIG. 6, the wireless environment data of a neighboring PS network 30 may build the database 140 for each cell. While performing the voice call, the mobile communication terminal 10 collects wireless environment data of the connected CS network 50. However, the mobile communication terminal 10 collects additionally wireless environment data of the neighboring PS network 30 and uses it as a criterion for determining the possibility of switching to the PS network after CSFB.

For the wireless environment data of neighboring PS networks 30, information of neighboring networks is collected by means of the inter radio access technology measurement (hereinafter, referred to as Inter RAT measurement) while the voice call is performed. The collected wireless environment data of the PS network 30 may include at least one of a reference signal received power (RSRP), a reference signal received quality (RSRQ), and a signal-to-noise ratio (SNR).

The types of information collected in operation S300 may be identical to the information collected in operation S 100. However, even though the wireless environment data of the PS network 30 to which the mobile communication terminal 10 connects is collected in operation S100, both the wireless environment data of the CS network 50 to which the mobile communication terminal 10 connects and the wireless environment data of the PS network 30 neighboring to the connected CS network 50 may be collected in operation S300. Therefore, even though the mobile communication terminal 10 is moving to another region while performing the voice call, the information of a PS network 30 in a region where the mobile communication terminal 10 passes last may be collected.

While the mobile communication terminal 10 performs a voice call, the information (third information) of neighboring networks may be collected by means of Inter RAT measurement and used as a criterion for determining the possibility of switching to the PS network after CSFB.

If the voice call ends in operation S500, the mobile communication terminal 10 may receive redirection information from the CS network 50 to redirect to the PS network 30 in operation S550.

In the related art, if the redirection information (redirection info) to the PS network 30 is received, the mobile communication terminal 10 releases the connection to the CS network 50, switches to the PS network 30, and attempts registration. However, if an electric field or wireless environment of the PS network 30 is bad, the registration to PS network 30 is frequently delayed or fails. Therefore, the mobile communication terminal 10 may not be capable of providing a communication during a period when the registration to the PS network 30 is being delayed or unsuccessful.

In order to address this problem, even though redirection info to the PS network 30 is received, the switching to the PS network 30 may not be instantly performed. The mobile communication terminal may determine whether to switch to the PS network based on the information (the first information, the second information, and/or the third information) collected respectively in operations S000, S100 (or S200), and S300 in operation S700.

By determining whether or not to switch to the PS network, it is judged to switch to the PS network 30 when the PS network 30 has a good electric field or other wireless environments, thereby determining the possibility of switching to the PS network. In order to determine the possibility of switching to the PS network, at least one of the information (the first to third information) collected in S000 to S300 is used.

For example, the switching to the PS network 30 may be decided by determining whether the corresponding information satisfies the one or more criteria. As a result of the determination, in a case where the corresponding information satisfies the one or more criteria, it is attempted to switch to the PS network 30 (S900). However, in a case where the corresponding information does not satisfy the one or more criteria, the redirection info for switching to the PS network 30 may be neglected for a guard time period, and the switching to the PS network 30 may be blocked for a while.

Hereinafter, S700 will be described in more detail. FIG. 7 is a flowchart illustrating a method for managing a registration to a PS network after terminating a CSFB procedure according to an exemplary embodiment of the present invention.

In operation S711, the mobile communication terminal 10 may determine the possibility of switching to the PS network at the location of the mobile communication terminal 10 when the voice call is terminated by using the back data (first information) of the PS network 30 collected during the operation S000.

The back data of the PS network 30 is a TAU failure frequency or a RACH connection failure frequency of each TA collected when the mobile communication terminal 10 is in an idle state (S000), and the back data may be used as a criterion for determining the possibility of switching to the PS network. For example, if the TAU failure frequency exceeds a first threshold value, the criterion for switching to the PS network is not satisfied and the mobile communication terminal 10 may determine not to switch back to the PS network 30 for a while.

As a result of determining the possibility of switching to the PS network in operation S711, if it is determined that the criterion for switching to the PS network is not satisfied, the switching to the PS network 30 may be blocked and the connection to the CS network 50 may be maintained in operation S730. If it is determined that the criterion for switching to the PS network is satisfied after evaluating the possibility of switching to the PS network 30, the switching to the PS network 30 may be performed in operation S900, or the mobile communication terminal 10 may perform the operation S713.

In operation S713, the mobile communication terminal 10 may further determine the possibility of switching to the PS network at the location of the mobile communication terminal 10 when the voice call is terminated by using the wireless environment data (second information) of the PS network 30 collected during operation S100.

The wireless environment data of the PS network 30 may be wireless environment data collected when the mobile communication terminal 10 starts sending or receiving a voice call in operation S100, and may be used as a criterion for determining the possibility of switching to the PS network. For example, if the RSRP or RSRQ is less than a second threshold value, the criterion for switching to the PS network is not satisfied.

If it is determined that the criterion for switching to the PS network is not satisfied after evaluating the possibility of switching to the PS network 30 in operation S713, the switching to the PS network 30 may be blocked, and the connection to the CS network 50 may be maintained in operation S730. If the criterion for switching to the PS network 30 is satisfied after evaluating the possibility of switching to the PS network 30 in operation S713, the switching to the PS network 30 may be performed in operation S900, or the mobile communication terminal may perform operation S715.

In operation S715, the mobile communication terminal 10 may determine the possibility of switching to the PS network at the location of the mobile communication terminal 10 when the voice call is terminated by using the wireless environment data (third information) of the PS network 30 neighboring to the CS network 50 collected in operation S300.

The wireless environment data of the neighboring PS network 30 is wireless environment data about each cell collected while the mobile communication terminal 10 performs a voice call in operation S300), and may be used as a criterion for determining the possibility of switching to the PS network 30. For example, if the RSRP or RSRQ is less than a third threshold value, the criterion for switching to the PS network is not satisfied.

If it is determined that the criterion for switching to the PS network is not satisfied after evaluating the possibility of switching to the PS network 30 in operation S715, the switching to the PS network 30 may be blocked, and the connection to the CS network 50 may be maintained in operation S730. If it is determined that the criterion for switching to the PS network 30 is satisfied after evaluating the possibility of switching to the PS network 30 in operation S715, the switching to the PS network 30 may be performed in operation S900.

As described above, if the mobile communication terminal 10 receives redirection info for switching back to the PS network 30, the possibility of switching to the PS network may be determined by using the first information, the second information, and/or the third information in operations S711, S713, and/or S715.

Operations for determining the possibility of switching to the PS network (S711, S713, and S715) may be performed in the order as shown in FIG. 7. However, Operations for determining the possibility of switching to the PS network (S711, S713, and S715) may be performed in a different order or selectively. Further, the operations S711, S713, and S715 may be performed individually or simultaneously based on the accumulated information including the first information, the second information, and the third information. Further, one of the operations S711, S713, and S715 may be omitted.

If the criterion for switching to the PS network is not satisfied, the mobile communication terminal 10 may maintain the connection to the CS network 50 in operation S730, and the mobile communication terminal 10 may collect wireless environment data (fourth information) of a PS network 30 neighboring to the connected CS network 50 in operation S750.

In the operation S750, the mobile communication terminal 10 is in an idle state where the mobile communication terminal 10 connects to the CS network 50 but may not perform a communication, and the duration of the idle state may be measured by a timer. In addition, information of neighboring networks (fourth information) may be collected by means of Inter RAT measurement as performed in operation S300.

Similar to operation S300, the database 140 about each cell may be built with the wireless environment data of the neighboring PS network 30. The wireless environment data of the neighboring PS network 30 may be used as a criterion for determining the possibility of switching to the PS network after CSFB.

The wireless environment data of the neighboring PS network 30 may include at least one of a reference signal received power (RSRP), a reference signal received quality (RSRQ), and a signal-to-noise ratio (SNR).

The mobile communication terminal 10 may collect information of neighboring networks by means of Inter RAT measurement while maintaining the connection to the CS network 50 after quitting the voice call, and may use the information as a criterion for determining the possibility of switching to the PS network after CSFB.

Further, if the mobile communication terminal 10 stays in an idle state in the CS network 50, it may be determined whether the duration of the idle state passes a guard time before determining whether to attempt switching to the PS network in operation S770.

If the duration of the idle state passes the guard time, in operation S790, the possibility of switching to the PS network at the location of the mobile communication terminal 10 when the guard time expires is determined by using the wireless environment data of the neighboring PS network 30 collected during operation S750. If the duration of the idle state does not pass the guard time, the idle state may be maintained until the guard time expires.

The wireless environment data (fourth information) of the neighboring PS network 30 is wireless environment data about each cell collected when the mobile communication terminal 10 connects to the CS network 50 and stays in an idle state in operation S750, and may be used as a criterion for determining the possibility of switching to the PS network. For example, if the RSRP, RSRQ, and/or SNR are less than a fourth threshold value, the criterion for switching to the PS network is not satisfied.

If the criterion for switching to the PS network is not satisfied after evaluating the possibility of switching to the PS network 30 in operation S790, the mobile communication terminal 10 may perform operation S750 again and another guard time period may be triggered. The second guard time may be set differently or equal to the first guard time. If the criterion for switching to the PS network is satisfied after evaluating the possibility of switching to the PS network 30 in operation S790, the switching to the PS network 30 may be performed in operation S900.

Thus, if the standard for switching to the PS network is satisfied, in operation S700, the switching to the PS network 30 may be performed in operation S900.

According to one operation or the combination of at least two operations for determining the possibility of switching to the PS network S711, S713, S715, and S790, the switching to the PS network 30 may be attempted when the criterion for switching to the PS network is satisfied (S910, see FIG. 2), and the registration to the PS network 30 may be completed (S930, see FIG. 2). The connection possibility of the PS network may be determined to be good or satisfied if the first information is less than (or equal) to a threshold value or if the second, third, and/or fourth information is greater than (or equal to) a threshold value.

According to the method for switching to the PS network after CSFB illustrated in the present disclosure, while the mobile communication terminal is in an idle state, back data (first information) about TA of the PS network 30 may be collected (S000 of FIG. 2, FIG. 3 or FIG. 7), and the possibility of switching to the PS network 30 may be determined by using the collected back data (S711). In addition, if it is detected to send or receive a voice call, wireless environment data (second information) about the connected PS network may be collected (S100 in FIG. 2 or FIG. 7), and the possibility of switching to the PS network may be determined by using the collected wireless environment data (S713).

Further, while the voice call is being performed, wireless environment data (third information) about a cell of a PS network neighboring to the connected CS network may be collected (S300), and the possibility of switching to the PS network may be determined by using the collected wireless environment data (S715). Further, while the CS network 50 maintains connection after the voice call ends, wireless environment data (fourth information) about a cell of the neighboring PS network is collected (S750), and the possibility of switching to the PS network is determined by using the collected wireless environment data (S790).

As illustrated in the aspects of the present disclosure, even though redirection info for switching to the PS network 30 is received, the switching to the PS network 30 may not be instantly performed, but the possibility of switching to the PS network may be determined based on the first, second, third, and/or fourth information. As a result, since the connection to the CS network 50 is maintained until the wireless environment of the PS network 30 to which the mobile communication terminal 10 is to switch becomes good, the continual connection of the mobile communication terminal 10 to the CS network is ensured. Therefore, the rate of success of sending or receiving a voice call may be enhanced by maintaining the connection to the CS network regardless of the registration delay or failure to the PS network 30. Further, the registration to the PS network may be delayed until the success probability for the switching back to the PS network is ensured while maintaining the connection to the CS network.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method that uses a processor to manage a circuit switched fall back (CSFB) procedure, comprising:
connecting to a circuit switched network for the CSFB procedure;
processing, using the processor, a voice call using the circuit switched network; and
determining whether to register to a packet switched network according to a connection possibility of the packet switched network.

2. The method of claim 1, wherein the connection possibility of the packet switched network is determined based on an inter Radio Access Technology (RAT) measurement.

3. The method of claim 1, wherein the connection possibility of the packet switched network is determined based on at least one of a tracking are update (TAU) failure frequency and a random access channel (RACH) connection failure frequency.

4. The method of claim 3, further comprising: calculating the TAU failure frequency or the RACH connection failure frequency during an idle state before initiating the CSFB procedure.

5. The method of claim 1, wherein the connection possibility of the packet switched network is determined based on at least one of a reference signal received power (RSRP), a reference signal received quality (RSRQ), and a signal-to-noise ratio (SNR) with respect to the packet switched network.

6. The method of claim 5, further comprising: calculating at least one of the RSRP, the RSRQ, and the SNR with respect to the packet switched network before connecting to the circuit switched network.

7. The method of claim 5, further comprising: calculating at least one of the RSRP, the RSRQ, and the SNR with respect to the packet switched network after connecting to the circuit switched network based on an inter Radio Access Technology (RAT) measurement.

8. The method of claim 1, further comprising: setting a guard time and maintaining the connection to the circuit switched network in response to a determination that the connection possibility of the packet switched network is lower than a threshold value.

9. The method of claim 8, further comprising: re-determining whether to register to the packet switched network if the guard time expires.

10. The method of claim 1, further comprising: recalculating the connection possibility of the packet switched network in response to a determination that the connection possibility of the packet switched network is lower than a threshold value.

11. The method of claim 1, further comprising: attempting a registration to the packet switched network if the connection possibility of the packet switched network is higher than or equal to a threshold value.

12. A mobile terminal, comprising:
a first mobile communication modem to connect to a packet switched network;
a second mobile communication modem to switch from the packet switched network to a circuit switched network; and
a controller to determine whether to re-register to the packet switched network according to a connection possibility of the packet switched network.

13. The mobile terminal of claim 12, wherein the connection possibility of the packet switched network is determined based on at least one of a tracking area update (TAU) failure frequency and a random access channel (RACH) connection failure frequency.

14. The mobile terminal of claim 12, wherein the connection possibility of the packet switched network is determined based on at least one of a reference signal received power (RSRP), a reference signal received quality (RSRQ), and a signal-to-noise ratio (SNR) with respect to the packet switched network.

15. The mobile terminal of claim 12, wherein the connection possibility of the packet switched network is determined based on an inter Radio Access Technology (RAT) measurement.

16. The mobile terminal of claim 12, wherein the controller sets a guard time and maintains the connection to the circuit switched network in response to a determination that the connection possibility of the packet switched network is lower than a threshold value.

17. The mobile terminal of claim 16, wherein the controller re-determines whether to register to the packet switched network if the guard time expires.

18. The mobile terminal of claim 12, wherein the controller recalculates the connection possibility of the packet switched network in response to a determination that the connection possibility of the packet switched network is lower than a threshold value.

19. The mobile terminal of claim 12, wherein the controller attempts a registration to the packet switched network if the connection possibility of the packet switched network is higher than or equal to a threshold value.

20. A method that uses a processor to manage a circuit switched fall back (CSFB) procedure, comprising:
connecting to a circuit switched network for the CSFB procedure;
processing, using the processor, a voice call using the circuit switched network; and
determining whether to register to a packet switched network if a guard time expires.
